(19) United States
(12) Patent Application Publication
(10) Pub. No.: US 2007/0271589 A1
(43) Pub. Date: Nov. 22, 2007

(54) METHOD FOR INTERACTIVE INTERNET PROTOCOL TELEVISION

(75) Inventors: Kumanan Yogaratnam, Ottawa (CA); Dat Doan, Toronto (CA)

Correspondence Address: VINCENT PATENT AGENCY, 11-300 EARL GREY DRIVE, SUITE 202, KANATA, ON, K2T 1C1, US

(73) Assignee: ESPIAL GROUP INC., Ottawa (CA)

(21) Appl. No.: 11/419,666

(22) Filed: May 22, 2006

(51) Int. Cl. H04N 7/173; H04N 7/16

(52) U.S. Cl. 725/113; 725/112; 725/135

(57) ABSTRACT

A method for interactive Internet protocol television in which program channels and an announcement channel are received over the IP medium. Triggers contained in the announcement channel can be used to alter a viewer's viewing experience. The bandwidth required for the announcement channel is not fixed, rather it is a function of the triggers contained therein. The program channels and the announcement channel can be provided by independent sources. The method can provide for efficient use of the bandwidth in the IP medium and can provide greater flexibility to the viewer with regard to the source of program and announcement channels.

### FIELD OF INVENTION

The present invention relates to the field of interactive television. In particular, to a method for interactive internet protocol (IP) television (TV).

### BACKGROUND

The term ‘interactive television’ (ITV) is used to describe a number of alternative implementations directed to allowing viewers to interact with television program content as they view. A viewer can alter his viewing experience based on triggers associated with program content by, for example pressing a button on a remote control unit in response to a prompt appearing on a television (TV) screen. A set-top box (STB) responds to the remote control unit button press by invoking a target application. It is through execution of the target application on the STB that the viewer's experience is altered. The target applications associated with the triggers can be transmitted to the STB using the same transmission infrastructure as that used for the program content. In some implementations of ITV a back-channel is also provided that allows information provided by the viewer (e.g. by making a selection using the remote control unit) to be sent back to the program content provider (e.g. via a cable head-end). The back-channel can use the same transmission media as the program content (e.g. digital cable) or it can use a separate transmission media (e.g. using a telephone line or Short Message Service (SMS) for program content provided via broadcast satellite).

FIG. 1 is a schematic representation of typical bandwidth allocation for program channel carriers 100A, 100B in a representative implementation of ITV, triggers 102 and target applications 103 can be transmitted by being encoded onto an unused portion 104 (e.g. the vertical blanking interval) of a carrier 100A (i.e. program channel) of the program content 101.

The doubled-headed arrow on the left side of the figures indicates a representative distribution of bandwidth in FIGS. 1, 2 and 6.

FIG. 2 is a schematic representation of typical bandwidth allocation in another representative implementation of ITV in which the triggers 102 and target applications 103 can be transmitted on a dedicated carrier 110 (ITV channel) separate from the carriers 100B for the program content 101 using an arrangement known as a ‘data carousel’. In the data carousel the triggers and target applications for one or more program channels are multiplexed in time on to the ITV channel. Each of the carriers 100B for the program content 101 typically include an unused portion 104. Typically, the data carousel content may not require the entire bandwidth allocated to the ITV channel 110 and there may be an unused portion 104 therein. The ITV channel is transmitted in a manner similar to the program channel and using the same transmission media. In order to process both a program channel to be viewed and the ITV channel a STB requires at least two tuners to decode the two channels concurrently. The contents (e.g. triggers 102 and target applications 103) contained in the ITV channel correspond to (i.e. are associated with) the program content in the carriers and therefore typically the ITV channel originates from the same source as the program channels.

In each of the arrangements represented in FIGS. 1 and 2 the bandwidth allocated for each program channel 100A, 100B and ITV channel 110 is fixed (e.g. 5 Mhz) and the bandwidth is required on a continuous basis. The ITV channel 110 uses the fixed continuous bandwidth whether or not it is all required by the trigger 102 and application 103 content of the ITV channel 110. The trigger 102 and application 103 content of the ITV channel 110 is also limited to be not greater than the fixed bandwidth allocated to the ITV channel 110. The ITV approaches represented in FIGS. 1 and 2 are typically used in transmission media such as over-the-air, cable and satellite broadcast.

The transmission of TV program content over the Internet or other similar broadband packet-mode media is referred to as internet protocol television (IP TV). FIG. 3 is a schematic representation of an exemplary topology for an IP TV environment 300. In IP TV a program content source (i.e. program channel) can be available to one or more viewers' set-top boxes (STB) 340 via a multicast packet data stream. The program channel originates from a head-end (HE) 310, is transmitted over a broadband medium (e.g. the Internet) to one or more digital subscriber line access multiplexers (DSLAM) 320. Each DSLAM 320 can transmit the program channel to one or more digital subscriber line (DSL) modems 330. Each DSL modem 330 is typically located in a viewer's premises. Each DSL modem 330 can provide the program channel to a STB 340 via a direct or local area network (LAN) connection. The HE 310, DSLAM 320 and DSL modems 330 can transmit multiple program channels, as described above, concurrently. A STB 340 can receive one of more multicast packet data streams (and therefore one or more program channels) simultaneously over a broadband connection. An ITV channel, where one is used, can be distributed from the HE 310 to STB 340 via DSLAM 320 and DSL modem 330 in a manner similar to that described above for program channels.

ITV can be implemented in IP TV using models similar to those described above for traditional broadcast media. That is, the triggers and target applications associated with a program content can be encoded onto the program content to form a single program channel that can be packetized and transmitted as a data stream over the broadband infrastructure. Alternatively, the triggers and target applications associated with a plurality of program channels can be encoded together (e.g. using a data carousel) to form an ITV channel that can be packetized and transmitted as a data stream over the broadband infrastructure. Each of the approaches described above using conventional ITV models within IP TV results in a fixed bandwidth requirement for each of the channels and interdependency between the ITV channel and the program channels.

In a typical cable or satellite distribution system a STB 340 can only receive program channels from a single HE 310 (or a single HE 310 at any one time in the case of satellite). In a conventional TV distribution system such as cable and satellite, the HE 310 is typically controlled by a single entity such as a cable or satellite television provider (herein after the distribution provider). The distribution provider sources each program channel from one of multiple program source providers such as a TV network (e.g. CNN, NBC, PBS), a production company, program distributor or an internal program source. The distribution provider may allow a viewer to choose a combination of program channels but the selection is limited to those provided (and therefore controlled) by the distribution provider.

Conventional TV distribution systems such as cable or satellite typically use a standing subscription model in which each viewer receives a predetermined selection of program channels with optional capability to receive some on-demand programming selected from a predetermined set.

What is needed is a method for interactive IP TV that can provide for efficient use of the bandwidth in the broadband infrastructure and which can provide greater flexibility to the viewer with regard to the source of program and ITV channels.

### SUMMARY OF INVENTION

A method for interactive Internet Protocol television in which program channels and an announcement channel are received over the IP medium. Triggers contained in the announcement channel can be used to alter a viewer's viewing experience. The bandwidth required for the announcement channel is not fixed, rather it is a function of the triggers contained therein. The program channels and the announcement channel can be provided by independent sources.

In accordance with an exemplary aspect, there is provided a method for providing interactive television over an internet protocol (IP) medium, the method comprising the steps of: receiving, over the IP medium, one or more program channels for presentation to a television viewer; receiving, over the IP medium, at least one announcement channel containing one or more triggers, wherein the bandwidth required for the announcement channel is a function of the one or more triggers; and altering the television viewer's viewing experience responsive to the one or more triggers.

Other aspects and features of the present invention will become apparent to those ordinarily skilled in the art or science to which it pertains upon review of the following description of specific embodiments of the invention in conjunction with the accompanying figures.

### BRIEF DESCRIPTION OF DRAWINGS

The present invention will be described in conjunction with drawings in which:

FIG. 1 is a schematic representation of bandwidth allocation in a representative implementation of ITV

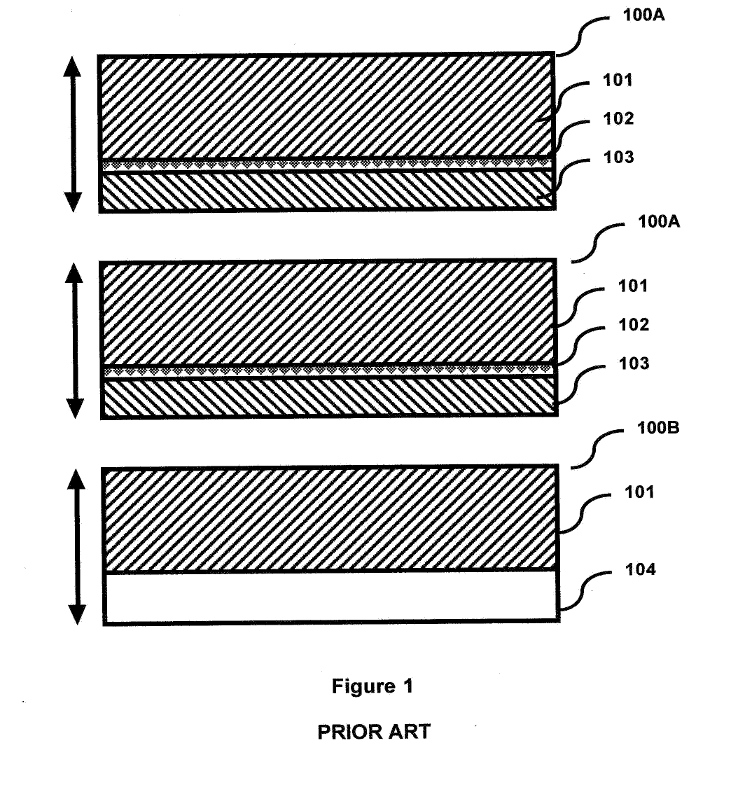

FIG. 2 is a schematic representation of bandwidth allocation in another representative implementation of ITV.

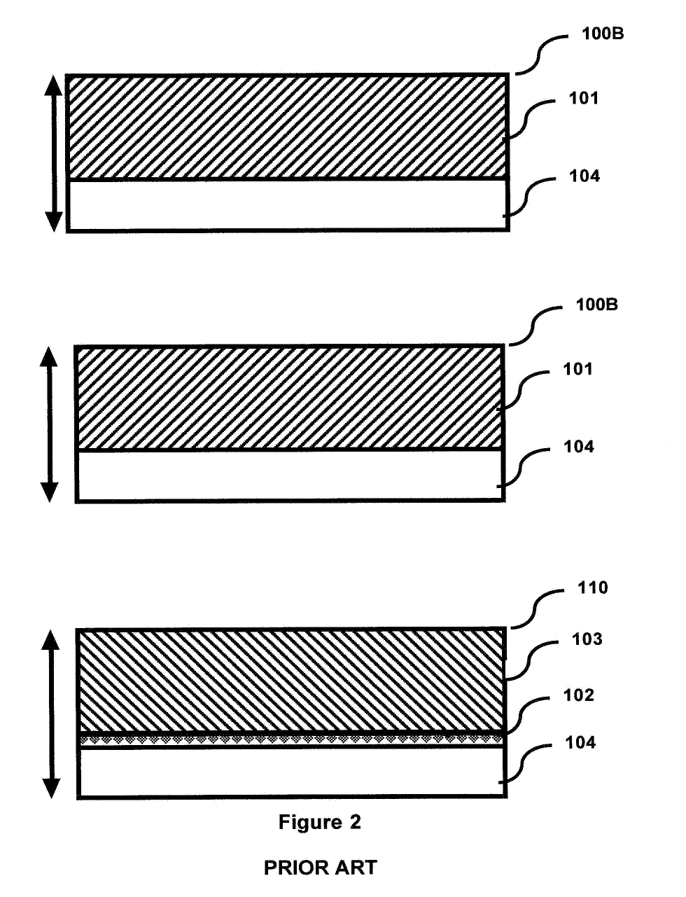

FIG. 3 is a schematic representation of an exemplary internet protocol (IP) television (TV) system in a typical operating environment.

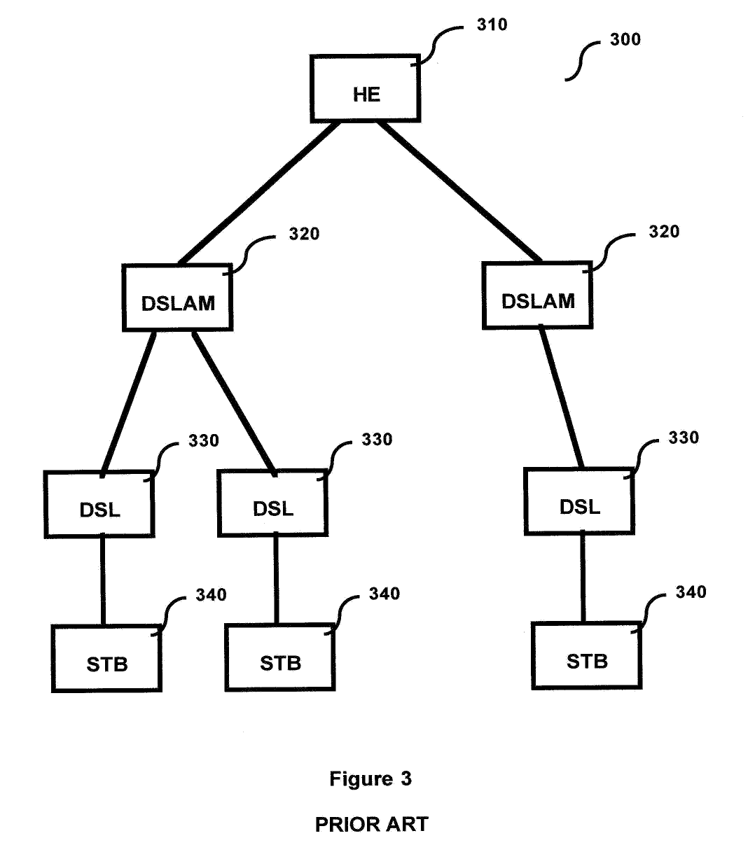

FIG. 4 is a schematic representation of inputs and outputs for an exemplary interactive IP TV terminal.

FIG. 5 is a schematic representation of the exemplary interactive IP TV terminal of FIG. 4 in a representative operating environment.

FIG. 6 is a schematic representation of bandwidth allocation in an exemplary interactive IP TV implementation.

FIG. 7 is a representation of steps in an exemplary method for interactive IP TV.

### DETAILED DESCRIPTION

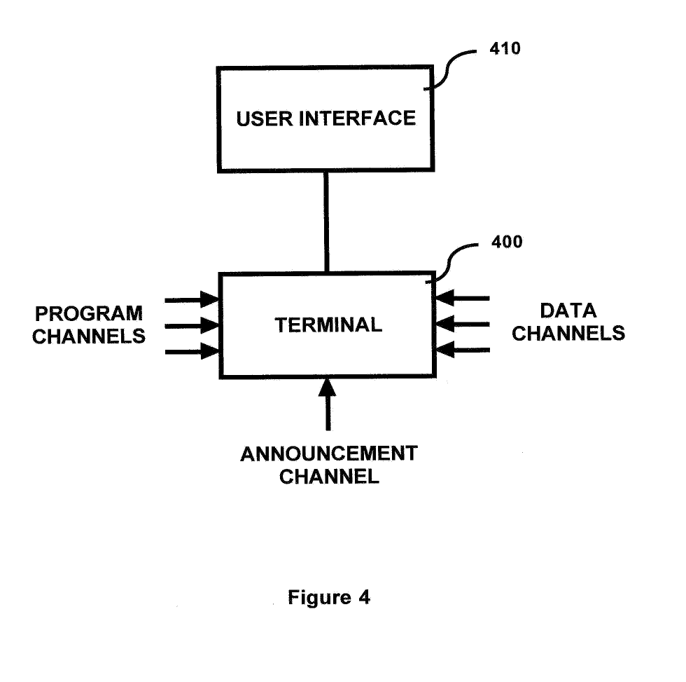

FIG. 4 is a schematic representation of inputs and outputs for an exemplary interactive IP TV terminal 400. The terminal 400 receives one or more program channels containing program content. The program channel content can be presented to a viewer via a user interface 410 (e.g. a television screen). The program channels are received over an IP medium such as, for example, a DSL connection. Each program channel can take the form of a streaming media channel over the IP medium. Each program channel originates from a program content provider. Each program channel can originate from a program content provider independent of that for any of the other program channels. More than one program channel can originate from the same program content provider. The bandwidth required for each program channel is a function of the program content contained therein.

The terminal 400 can receive at least one announcement channel containing one or more triggers. The announcement channel is received over the IP medium. The bandwidth utilized by the announcement channel is a function of the one or more triggers and preferably is minimized in accordance with the one or more triggers. The data packets in the IP medium representing the content of the announcement channel can be received asynchronously by the terminal 400. The one or more triggers can be transmitted only as needed. The announcement channel originates from an announcement content provider. The announcement channel can use a well known protocol such as, for example, the Internet Engineering Task Force (IETF) Request For Comment (RFC) 2974 entitled Session Announcement Protocol (SAP). The announcement content provider can be independent of the program content provider of each of the one or more program channels. The triggers contained in the announcement channel can be independent of the program channels, correspond to the contents of any of the program channels or a combination thereof. In an alternative embodiment, the announcement channel can also contain one or more target applications that each correspond to one or more of the triggers in the announcement channel. The bandwidth utilized by the announcement channel can be a function of the one or more triggers and of the one or more target applications. The bandwidth is preferably minimized in accordance with the one or more triggers and of the one or more target applications. In an alternate embodiment more than one announcement channel can be received concurrently by the terminal 400, with each announcement channel operating as described above.

The terminal 400 also can receive one or more data channels. The data channels are received over the IP medium. Each data channel can provide applications, content data and combinations thereof. The applications can be target applications for the triggers contained in the announcement channel. The content data can be used by target applications executing on the terminal 400 and presented in the user interface to the viewer. For example, the content data can provide information such as professional sporting game results or other similar information that can be posted onto the user interface by a target application such as a ‘football league results summary’ target application executing on the terminal 400 in response to a trigger. The triggers in the announcement channel can contain references to data content in one or more of the data channels. Each of the data channels can be arranged as a data carousel. Alternatively, triggers in the announcement channel can contain references to a web server designated by a universal resource locater (URL) or other similar locator. The web server can be a bidirectional data source that responds to requests for content data received from the terminal 400.

The terminal 400 can use the one or more triggers to alter the viewing experience of a viewer through a user interface 410 such as a television. For example, while the viewer is viewing one of the program channels, the terminal can add a visual prompt to the television screen based on one of the triggers. When the viewer responds to the visual prompt, a target application corresponding to the trigger can be executed. The target application can be built-in or stored on the terminal 400 or can be received as needed from a data channel. Applications stored in the terminal 400 can have been previously received from the announcement channel or from a data channel and stored in volatile or no-volatile memory in the terminal 400. The application can alter the viewer's experience by supplementing or augmenting the contents of a program channel the viewer is viewing (e.g. by captioning or overlaying widgets on the screen), by presenting content in addition to a program channel (e.g. using split screen or picture-in-picture presentation), by replacing the program content being viewed with alternative content (e.g. presenting a web browser or email client user interface) and other similar approaches to alter the content being presented to the viewer.

In addition to triggers received on the announcement channel, the terminal 400 can also receive a trigger encoded into any of the one or more program channels. A trigger can also be derived from other information such as previously captured viewer preferences, program guide (i.e. schedule) information and other similar information. Viewer preferences can include preferred programs (e.g. ‘Movie of the Week’), categories of programming (e.g. news coverage, educational television, home improvement), preferred viewing times (e.g. weekdays between 7:00 and 10:00 PM). Based on individual or combinations of viewer preferences the terminal 400 can present the viewer with one or more triggers selected from the triggers received in the announcement channel that are likely to be of interest to the viewer. The viewer's preference can be combined with other factors such as, for example, time-of-day, day-of-week, and content data received on a data channel when selecting which triggers to present to the viewer.

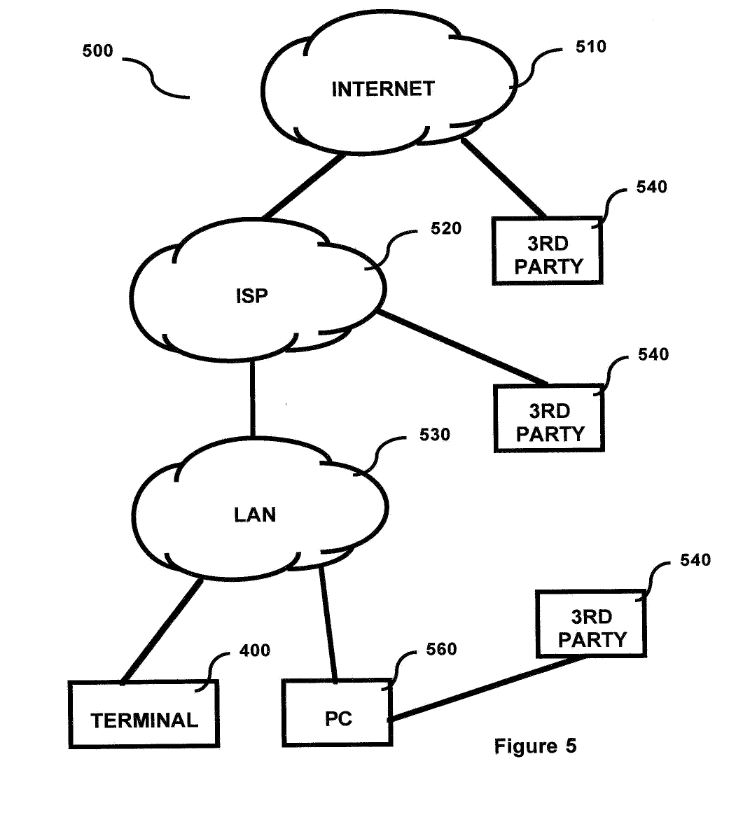

FIG. 5 is a schematic representation of the exemplary interactive IP TV terminal 400 of FIG. 4 in a representative operating environment 500. The terminal 400 can, for example, be connected to a local area network (LAN) 530 via an IP medium such as Ethernet. Other devices such as a personal computer (PC) 560 can be connected to the LAN 530 and be in IP communications with the terminal 400. The LAN 530 can be connected to an internet service provide (ISP) 530 via an IP medium (e.g. using a DSL or cable modem). The ISP 530 provides IP connectivity to the Internet 510. In an alternative embodiment the ISP 520 can also provide connectivity to other IP capable infrastructure such as, for example, a private network (not illustrated). Program channels, data channels and the announcement channel can originate at various points within the IP infrastructure represented in FIG. 5. For example, program channels can be provided by the ISP 520. In an alternative embodiment program channels can be provided by a 3^{rd} party 540. The program channel streams provided by the 3^{rd} party 540 can enter the IP infrastructure at any of the Internet 510, the ISP 520, the PC 560 connected to the LAN 530 and combinations thereof. Similarly, the announcement channel and the data channels can be provided by 3^{rd} parties 540 and can enter the IP infrastructure as described above with reference to the program channels. Each of the program channels, the announcement channel and each of the data channels can be provided by an independent 3^{rd} party 540 acting as the program content provider, the announcement provider and the data content provider respectively.

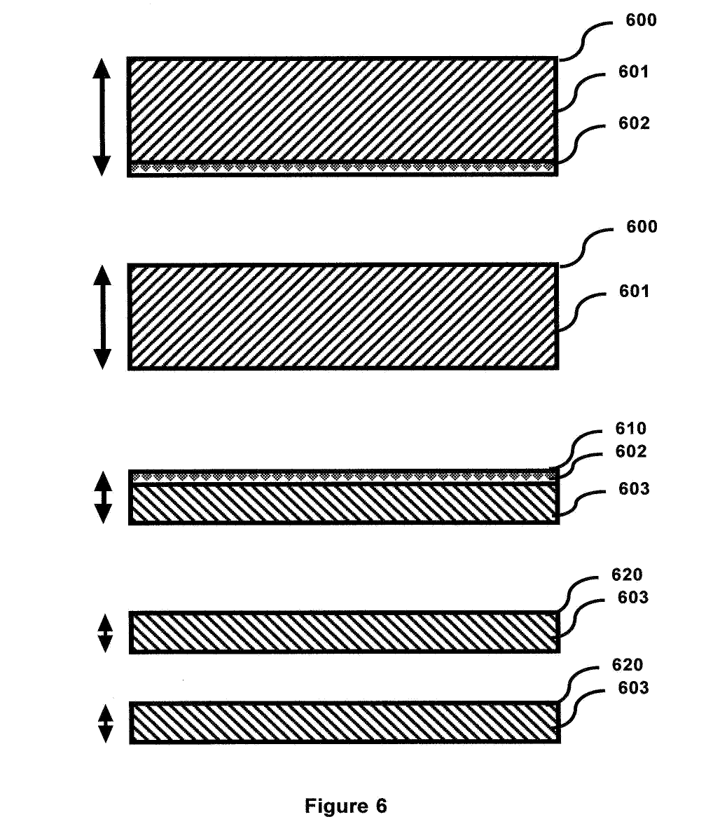

FIG. 6 is a schematic representation of bandwidth allocation for the interactive IP TV terminal 400 represented in FIG. 4. One or more program channels 600 are provided each having sufficient bandwidth for the aggregate of the contained program content 601 (e.g. Moving Picture Experts Group—4 (MPEG4) encoded) and any optional associated triggers 602. The combined program content 601 and triggers 602 in each program channel 600 can be packetized and provided as a single stream by the program content provider

At least one announcement channel 610 is provided having bandwidth that is a function of triggers 602 contained therein. Alternatively, the announcement channel 610 can contain triggers 602 and target applications 603. In the alternate case the bandwidth of the announcement channel 610 is a function of the triggers 602 and the target applications 603 contained therein. In either alternative the bandwidth of the announcement channel 610 can be a further function of other parameters such as, for example, quality of service (QoS) objectives and other content contained therein.

Each announcement channel 610 can be provided over a multicast IP connections such as, for example, one based on the Internet Group Management Protocol (IGMP) defined in IETF RFC 1112. Alternatively other non-multicast types of connections that allow the source of the announcement channel 610 to send triggers to multiple terminals 400 such as, for example, IP broadcast can be used. The announcement channel 610 delivers one or more triggers. Each trigger can be a single packet in the well known User Datagram Protocol (UDP), from the Internet protocol suite, that contains information about the trigger (including target application, version, and other similar information) as well as a payload that describes a session (i.e. a session payload) associated with the trigger.

The session identifies one or more data channels 620 that are associated with the trigger. The identities of the data channels 620 can be contained in the session payload or alternatively the session payload can contain references to a data source that identifies the data channels 620.

The data source can be local to the terminal 400 or alternatively can reside on another system (e.g. a server) accessible via an IP connection. The data source reference can be specific to an application. The data source reference can, for example, be a reference to a data carousel that can be implemented as one or more multicast channels each containing one or more data channels 620 where the data channels 620 can be multiplexed. Alternatively the data source reference can be a reference to a web server in accordance with, for example, HyperText Transfer Protocol (HTTP) as defined in the World Wide Web Consortium (W3C) RFC 2616 or File Transfer Protocol (FTP) as defined in IETF RFC 0959. The web server is accessible via an IP connection and can be located in the publicly accessible Internet or alternatively in a private network such as, for example, a private network controlled by the program channel provider.

The terminal 400 monitors the announcement channel 610. Meta-data contained in each trigger received on the announcement channel 610 is used by the terminal 400 to identify the purpose of the trigger and to determine the trigger's applicability to the viewer. When a trigger is detected that is applicable to the viewer (e.g. a trigger related to a program channel 600 being viewed, related to a viewer specified topic of interest, or containing an advertisement) the viewer's viewing experience can be altered by making a target application referenced by the trigger available to the viewer.

One or more data channels 620 can be provided each having sufficient bandwidth for contained target applications associated with one or more triggers and other data content. Each data channel 620 can be packetized and provided as a separate data stream by a data content provider. Alternatively, one or more data channels 620 can be encoded (e.g. multiplexed) onto a single data stream. The terminal 400 only needs to receive a data channel 620 when a trigger has been selected that has a target application in the data channel 620. Use of the data channel 620 can be on-demand in response to a trigger selection. Alternatively, the terminal 400 can receive one or more data channels 620 associated with a program channel 600 being viewed by a viewer or with the announcement channel and the target applications contained in the data channels can be cached (i.e. stored) in the terminal 400. A target application cached in the terminal 400 can be used when a corresponding trigger is selected. In a further alternative embodiment, a combination of on-demand data channel access and terminal 400 caching of target applications can be used.

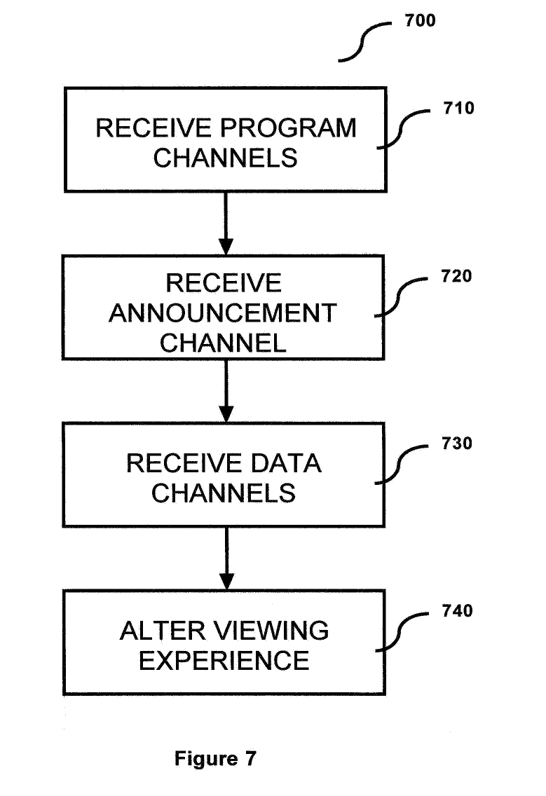

FIG. 7 is a representation of steps in an exemplary method 700 for interactive TV over an IP medium. The method can be implemented using a system for interactive IP TV as described above with reference to FIGS. 4, 5 and 6. In step 710 one or more program channels are received over the IP medium for presentation to a television viewer. The one or more program channels can be provided by one or more program content providers. In step 720 at least one announcement channel containing one or more triggers is received over the IP medium. The bandwidth required for the announcement channel is a function of the one or more triggers. The announcement channel can be received asynchronously. In an alternate embodiment the announcement channel can also contain one or more target applications each associated with one of the one or more triggers. The bandwidth required for the announcement channel is a function of one or more triggers and the one or more target applications contained therein. The announcement channel can be provided by an announcement content provider. In step 730 one or more data channels having content associated with the one or more triggers is received. Receiving of the one or more data channels is optional. Each of the one or more data channels can contain one or more target applications each associated with one of the one or more triggers. The one or more data channels can be provided by one or more data content providers. In step 740 the viewer's viewing experience is altered responsive to one of the one or more of the triggers. In an embodiment in which the one or more data channels of step 730 are received, content of the data channels can also be utilized in the altering of the viewer's experience. Each of the program content providers, announcement content provider and the data content providers can be independent of one and other.

The method for interactive IP TV described above with reference to FIGS. 4, 5, 6 and 7 can provide for efficient use of the bandwidth in the broadband infrastructure and which can provide greater flexibility to the viewer with regard to the source of program and announcement channels.

It will be apparent to one skilled in the art that numerous modifications and departures from the specific embodiments described herein may be made without departing from the spirit and scope of the present invention.

1. A method for providing interactive television over an internet protocol (IP) medium, the method comprising the steps of:
receiving, over the IP medium, one or more program channels for presentation to a television viewer;
receiving, over the IP medium, at least one announcement channel containing one or more triggers, wherein the bandwidth required for the announcement channel is a function of the one or more triggers; and
altering the television viewer's viewing experience responsive to the one or more triggers.

2. The method of claim 1, wherein the at lease one announcement channel also contains one or more target applications each associated with one of the one or more triggers, and wherein the bandwidth required for the announcement channel is a function of the one or more triggers and the one or more target applications.

3. The method of claim 1, further comprising the step of:
receiving one or more data channels having content associated with the one or more triggers;
wherein data channel content can be utilized in the step of altering the televisions viewer's viewing experience.

4. The method of claim 3, wherein the content of the data channels includes one or more target applications each associated with one of the one or more triggers.

5. The method of claim 1, wherein a content provider of the announcement channel is independent of a program provider of the one or more program channels.

6. The method of claim 3, wherein an announcement content provider of the announcement channel is independent of a program content provider of the one or more program channels and a data content provider of each of one or more data channels is independent of the program content provider.

7. The method of claim 5, wherein the data content provider is independent of the program content provider.

8. The method of claim 1, wherein the at least one announcement channel is received asynchronously.

9. The method of claim 1, the at least one announcement channel further containing one or more target applications each corresponding to one of the triggers, wherein the bandwidth required for the announcement channel is a function of the one or more triggers and the one or more target applications.

10. The method of claim 1, wherein any of the one or more announcement channels being provided over a multicast IP connection.

11. The method of claim 1, wherein any of the one or more announcement channels being provided over a non-multicast IP connection from a single source to multiple receivers.

12. The method of claim 3, wherein each of the one or more triggers is contained in a single packet in accordance with the User Datagram Protocol (UPD).

13. The method of claim 3, each of the one or more triggers containing a session payload that identifies one or more of the data channels, wherein content of the identified data channels can be utilized in the step of altering the televisions viewer's viewing experience.

14. The method of claim 3, each of the one or more triggers containing a session payload having references to a data source that identifies one or more of the data channels, wherein content of the identified data channels can be utilized in the step of altering the televisions viewer's viewing experience.

15. The method of claim 14, wherein the data source is a web server accessible over the IP medium.

16. The method of claim 3, wherein the one or more data channels can multiplexed in a data carousel received over a multicast channel.

17. The method of claim 1, each of the one or more triggers further containing meta-data; and wherein the meta-data can be used in determining to which of the one or more triggers altering of the viewing experience is responsive.
